(19) United States
(12) Patent Application Publication
(10) Pub. No.: US 2017/0285397 A1
(43) Pub. Date: Oct. 5, 2017

(54) METHOD OF MANUFACTURING ELECTRO-OPTICAL DEVICE, ELECTRO-OPTICAL DEVICE, AND ELECTRONIC APPARATUS

(71) Applicant: SEIKO EPSON CORPORATION, Tokyo (JP)

(72) Inventor: Toru NIMURA, Matsumoto-shi (JP)

(73) Assignee: SEIKO EPSON CORPORATION, Tokyo (JP)

(21) Appl. No.: 15/474,448

(22) Filed: Mar. 30, 2017

(30) Foreign Application Priority Data
Apr. 4, 2016 (JP) 2016-074974

(51) Int. Cl. G02F 1/1335; G02F 1/1362; G02F 1/1343; G02F 1/1368

(52) U.S. Cl. CPC G02F 1/133526; G02F 1/1368; G02F 1/136213; G02F 1/134309; G02F 1/13439; G02F 2201/123; G02F 2201/121; G02F 2001/133302

(57) ABSTRACT

In a step of forming an element substrate of an electro-optical device, a layered structure, which includes a plurality of films having a film that forms pixel switching elements and a film that forms holding capacitors, is formed on one surface of the substrate, and, thereafter, a lens surface and a lens layer are formed on a second surface of the layered structure. Subsequently, after the substrate is removed by polishing and etching, pixel electrodes are formed on a side of a first substrate, on which the substrate is located, of the layered structure. Therefore, the holding capacitors are provided on a side opposite to a side of the pixel electrodes (side of a counter substrate) for the pixel switching elements.

### BACKGROUND

### 1. Technical Field

The present invention relates to a method of manufacturing an electro-optical device, in which lenses are formed to correspond to pixel electrodes, the electro-optical device, and an electronic apparatus.

### 2. Related Art

In an electro-optical device (liquid crystal apparatus) which is used as a light valve or the like of a projection-type display apparatus, a liquid crystal layer is disposed between an element substrate, on which pixel electrodes and pixel switching elements are formed, and a counter substrate, on which common electrodes are formed. In the electro-optical device, a configuration is proposed in which a plurality of lenses that overlap the plurality of respective pixel electrodes in plan view are formed on the element substrate in order to improve image qualities. In addition, in a case where the lenses are formed on the element substrate, a technology is proposed in which a lens surface, which includes a concave surface, is formed on the substrate, a lens layer is formed on the whole surface thereof, and lenses are formed by flattening the surface of the lens layer (refer to JP-A-2004-258052).

In JP-A-2004-258052, in a case where the flattening is performed, the lens layer remains over the entire one surface of the substrate in addition to the inside of the concave surface. In the configuration, the lens layer is formed on the entire surface of the substrate regardless of a large difference in thickness of the lens layer in an in-plane direction of the substrate. Therefore, in a case where high temperature is applied to the lens layer in a step after forming the lens layer, stress is concentrated on specific spots of the lens layer due to the difference in thickness. For example, in a case in which high temperature is applied to the lens layer in a step of forming a semiconductor layer, which includes polysilicon, of the pixel switching elements and a step of forming a gate electrode through a thermal oxidation method after the lens layer is formed, stress is concentrated on the specific spots of the lens layer due to the difference in thickness. Since the stress causes cracks to be generated in the lens layer, it is not preferable.

### SUMMARY

An advantage of some aspects of the invention is that it provides a method of manufacturing an electro-optical device, the electro-optical device, and an electronic apparatus which are capable of preventing cracks from being generated in a lens layer even in a case where lenses are provided in an element substrate.

According to an aspect of the invention, there is provided a method of manufacturing an electro-optical device including an element substrate, on which pixel electrodes, pixel switching elements electrically connected to the pixel electrodes, and holding capacitors electrically connected to the pixel electrode are provided, a counter substrate on which common electrodes that face the pixel electrodes are provided, and an electro-optical layer which is provided between the element substrate and the counter substrate, the method including forming the element substrate including forming a layered structure, which includes a plurality of films having a film that forms the pixel switching elements and a film that forms the holding capacitors, on one surface of the substrate; removing the substrate from another surface of the substrate after the forming of the layered structure; forming the pixel electrodes on a first surface of the layered structure which is a surface on a side, which is opposite to the holding capacitors, of the pixel switching elements, after the removing of the substrate; and providing a first lens surface, which includes a concave surface or a convex surface, and a first light-transmitting lens layer, which covers the first lens surface, on a second surface, on which the holding capacitors are located for the pixel switching elements, of the layered structure after the forming of the layered structure is performed.

The electro-optical device, which is manufactured by the manufacturing method, includes an element substrate, on which pixel electrodes, pixel switching elements electrically connected to the pixel electrodes, and holding capacitors electrically connected to the pixel electrode are provided; a counter substrate on which common electrodes that face the pixel electrodes are provided; and an electro-optical layer which is provided between the element substrate and the counter substrate, the element substrate includes a layered structure, which includes a plurality of films having a film that forms the pixel switching elements and a film that forms the holding capacitors, a first lens surface, which includes a concave surface or a convex surface that overlaps the pixel electrodes, on a side, which is opposite to the counter substrate, of the layered structure, and a first light-transmitting lens layer which covers the first lens surface from a side opposite to the layered structure, the holding capacitors are provided on a side opposite to the counter substrate for the pixel switching elements, and the pixel electrodes are provided on a counter substrate side of the layered structure.

According to the aspect of the invention, the pixel electrodes are provided on the first surface of the layered structure, which includes the plurality of films having the film that forms the pixel switching elements and the film that forms the holding capacitors, and the first lens surface and the first lens layer are provided on the second surface of the layered structure. Therefore, since the first lens layer is formed after the forming the pixel switching elements or the like, heat, which is generated when the pixel switching elements or the like are formed, is not added to the first lens layer. Accordingly, large stress is hardly concentrated on specific spots of the first lens layer. Therefore, it is possible to prevent a problem in that cracks are generated in the first lens layer and a problem in that the first lens layer is peeled off due to the cracks from being generated. In addition, since a part of the substrate or the whole substrate is removed after forming the pixel switching elements, the holding capacitors, and the like on one surface of the substrate, it is possible to prevent the element substrate from being thick even though the lenses are provided. In addition, since the element substrate becomes thin, it is possible to effectively release heat generated when wirings or the like absorb light.

In the method of manufacturing an electro-optical device according to the invention, it is preferable that the removing of the substrate include completely removing the substrate. In the electro-optical device, which is manufactured by the manufacturing method, the pixel electrodes are laminated on the surface of the layered structure on the counter substrate side, and a substrate is not provided between the pixel electrodes and the layered structure. Therefore, it is possible to cause the element substrate to be thin.

Here, the forming of the element substrate may include forming the layered structure after forming an etching stopper layer on the one surface of the substrate, and the removing of the substrate may include etching the substrate to remove the substrate until reaching at least the etching stopper layer, and removing the etching stopper layer after the etching of the substrate.

In the method of manufacturing an electro-optical device according to the invention, the substrate may be a light-transmitting substrate, and the removing of the substrate may include thinning the substrate and remaining a part of the substrate in a thickness direction. In the electro-optical device, which is manufactured by the manufacturing method, the element substrate may include a light-transmitting substrate between the pixel electrodes and the layered structure, the layered structure may be laminated on a surface of the substrate on a side opposite to the counter substrate, and the pixel electrodes may be laminated on a surface of the substrate on the counter substrate side.

According to the aspect of the invention, the method of manufacturing an electro-optical device may further include pasting a lens array substrate, which includes the first lens surface and the first lens layer, to the second surface of the layered structure by an adhesive layer in the providing of the first lens surface and the first lens layer after the forming of the layered structure and before the removing of the substrate; and performing the removing of the substrate and the forming of the pixel electrodes in a state in which the lens array substrate is pasted to the second surface of the layered structure. In the electro-optical device, which is manufactured by the manufacturing method, the element substrate may include a lens array substrate which has the first lens surface and the first lens layer, and the lens array substrate may be pasted to a surface of the layered structure on a side opposite to the counter substrate by an adhesive layer. In a case where the lens array substrate is a crystal substrate or a sapphire substrate, a thermal conductivity of the lens array substrate is high, and thus it is possible to effectively release heat generated in the element substrate through the lens array substrate.

According to the aspect of the invention, the method of manufacturing an electro-optical device may further include forming a light-transmitting film on the second surface of the layered structure, and, thereafter, forming the first lens surface on the light-transmitting film in the providing of the first lens surface and the first lens layer after the forming of the layered structure and before the removing of the substrate; and performing the removing of the substrate and the forming of the pixel electrodes in a state in which the support substrate is pasted to the second surface of the layered structure by an adhesive layer. In the electro-optical device, which is manufactured by the manufacturing method, the element substrate includes the light-transmitting film in which the first lens surface is formed on a side, which is opposite to the counter substrate, of the layered structure. In this case, in the method of manufacturing an electro-optical device, it is preferable that the support substrate be a light-transmitting substrate and that the support substrate remain in the electro-optical device. In the electro-optical device, which is manufactured by the manufacturing method, the element substrate includes the light-transmitting support substrate on a side, which is opposite to the layered structure, of the light-transmitting film. According to the configuration, the electro-optical device has sufficient rigidity. In addition, it is preferable that the support substrate be a crystal substrate or a sapphire substrate. In a case where the support substrate is the crystal substrate or the sapphire substrate, a thermal conductivity of the support substrate is high, and thus it is possible to effectively release heat generated in the element substrate through the support substrate.

According to the aspect of the invention, the method of manufacturing an electro-optical device may further include forming a connection section, which electrically connects the pixel switching elements to the pixel electrodes, on the first surface of the layered structure after the removing of the substrate and before the forming of the pixel electrodes. In addition, according to the aspect of the invention, the method of manufacturing an electro-optical device may further include forming a connection section, which electrically connects the pixel switching elements to the pixel electrodes, on one surface of the substrate in the forming of the layered structure.

According to the aspect of the invention, in the method of manufacturing an electro-optical device and the electro-optical device, the counter substrate may be provided with a second lens surface, which includes a concave surface or a convex surface that overlaps the pixel electrodes, and a second light-transmitting lens layer which covers the second lens surface.

The electro-optical device according to the aspect of the invention is used for various electronic apparatuses. For example, the electronic apparatus may include a light source section that causes light to be incident to the element substrate side for the electro-optical device. In addition, among various electronic apparatuses, an electro-optical device is used for a projection-type display apparatus, the projection-type display apparatus is provided with the light source section that emits light which is supplied to the electro-optical device, and a projection optical system that projects light which is modulated by the electro-optical device.

### BRIEF DESCRIPTION OF THE DRAWINGS

The invention will be described with reference to the accompanying drawings, wherein like numbers reference like elements.

FIG. 1 is a plan view illustrating an electro-optical device to which the invention is applied.

FIG. 2 is a sectional view illustrating an electro-optical device according to a first embodiment of the invention.

FIG. 3 is a plan view illustrating a plurality of pixels which are adjacent to each other in the electro-optical device illustrated in FIG. 2.

FIG. 4 is a sectional view illustrating a part of the electro-optical device illustrated in FIG. 2.

FIG. 5 is a sectional view illustrating steps of a method of manufacturing the electro-optical device illustrated in FIG. 2.

FIG. 6 is a sectional view illustrating steps of a method of forming a connection section illustrated in FIG. 4.

FIG. 7 is a sectional view illustrating an electro-optical device according to a second embodiment of the invention.

FIG. 8 is a sectional view illustrating steps of a method of manufacturing the electro-optical device illustrated in FIG. 7.

FIG. 9 is a sectional view illustrating an electro-optical device according to a third embodiment of the invention.

FIG. 10 is a sectional view illustrating an electro-optical device according to a fourth embodiment of the invention.

FIG. 11 is a sectional view illustrating an electro-optical device according to a fifth embodiment of the invention.

FIG. 12 is a schematic configuration view illustrating a projection-type display apparatus (electronic apparatus) using the electro-optical device to which the invention is applied.

### DESCRIPTION OF EXEMPLARY EMBODIMENTS

Embodiments of the invention will be described with reference to the accompanying drawings. Meanwhile, in the drawings which are referred to in the description below, each layer and each member are shown at sizes which can be recognized in the drawing, and thus the scales thereof are different for each layer and each member. In addition, in the description below, in a case where a layer which is formed on an element substrate is described, “an upper layer side” means a side on which a counter substrate is located, and “a lower layer side” means a side opposite to a side on which the counter substrate is located. In contrast, in a case where the layer which is formed on the counter substrate is described, the “upper layer side” means a side on which the element substrate is located, and the “lower layer side” means a side opposite to a side on which the element substrate is located.

### First Embodiment

### Configuration of Electro-Optical Device

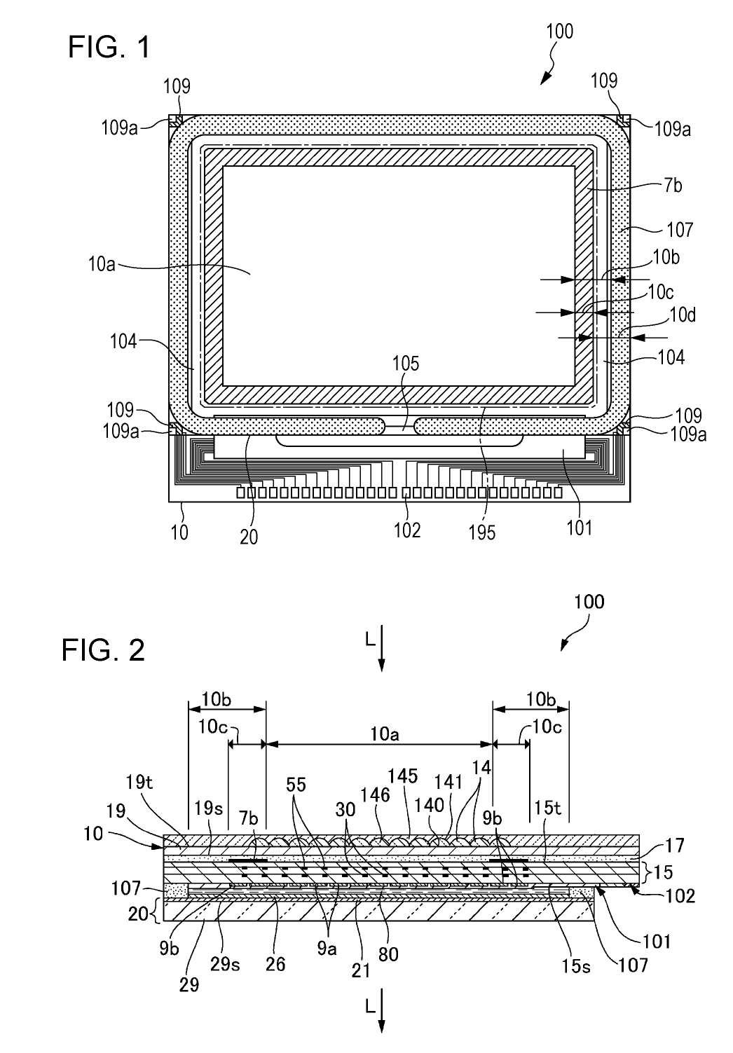

FIG. 1 is a plan view illustrating an electro-optical device 100 to which the invention is applied. FIG. 2 is a sectional view illustrating an electro-optical device 100 according to a first embodiment of the invention. As illustrated in FIGS. 1 and 2, in the electro-optical device 100, an element substrate 10 and a counter substrate 20 are pasted by a seal material 107 with a predetermined gap, and the element substrate 10 faces the counter substrate 20. The seal material 107 is provided in a frame shape along the outer edge of the counter substrate 20, and an electro-optical layer 80, such as a liquid crystal layer, is disposed in an area which is surrounded by the seal material 107 between the element substrate 10 and the counter substrate 20. Accordingly, the electro-optical device 100 is formed as a liquid crystal apparatus. The seal material 107 is a photosetting adhesive or a photosetting and thermosetting adhesive, and contains a gap material, such as glass fibers or glass beads, in order to set a distance between both the substrates to a predetermined value.

Both the element substrate 10 and the counter substrate 20 have a square shape, and a display area 10a is provided at an approximately center of the electro-optical device 100 as a square-shaped area. According to the shape, the seal material 107 is also provided in an approximately square shape, and a rectangular-shaped peripheral area 10b is provided between an inner periphery of the seal material 107 and an outer periphery of the display area 10a.

A data line drive circuit 101 and a plurality of terminals 102 are formed along one side of the element substrate 10 on the outside of the display area 10a on a surface of the element substrate 10 on the side of the counter substrate 20, and a scan line drive circuit 104 is formed along another side which is adjacent to the one side. A flexible wiring substrate (not shown in the drawing) is connected to the terminals 102, and various potentials and various signals are input to the element substrate 10 through the flexible wiring substrate.

A plurality of light-transmitting pixel electrodes 9a, which include Indium Tin Oxide (ITO) films or the like, holding capacitors 55, and pixel switching elements 30, which are electrically connected to the plurality of respective pixel electrodes 9a, are formed in a matrix shape in the display area 10a on the surface of the element substrate 10 on the side of the counter substrate 20. A first oriented film 16 is formed on the pixel electrodes 9a on the side of the counter substrate 20, and the pixel electrodes 9a are covered by the first oriented film 16.

A light-transmitting common electrode 21, which includes an ITO film, is formed on the side of a surface of the counter substrate 20 which faces the element substrate 10, and a second oriented film 26 is formed on the common electrode 21 on the side of the element substrate 10. The common electrode 21 is formed on approximately the entire surface of the counter substrate 20 and is covered by the second oriented film 26.

The first oriented film 16 and the second oriented film 26 are formed of an inorganic oriented film (perpendicular oriented film) that includes a diagonally vapor-deposited film, such as SiOₓ (x<2), SiO₂, TiO₂, MgO, or Al₂O₃, and liquid crystal molecules, which include negative dielectric anisotropy that is used for the electro-optical layer 80, are aligned at an incline. Therefore, the liquid crystal molecules form a predetermined angle for the element substrate 10 and the counter substrate 20. In this manner, the electro-optical device 100 is formed as a liquid crystal apparatus in a Vertical Alignment (VA) mode.

In the element substrate 10, inter-substrate conduction electrodes 109 are formed in areas, which overlap the corner parts of the counter substrate 20 on the outer side of the seal material 107, in order to enable electrical conduction between the element substrate 10 and the counter substrate 20. In the inter-substrate conduction electrodes 109, inter-substrate conduction materials 109a, which include conductive particles, are disposed. The common electrode 21 of the counter substrate 20 is electrically connected to the side of the element substrate 10 via the inter-substrate conduction materials 109a and the inter-substrate conduction electrodes 109. Therefore, a common potential is applied to the common electrode 21 from the side of the element substrate 10.

In the electro-optical device 100 of the embodiment, the pixel electrodes 9a and the common electrodes 21 are formed of an ITO film (light-transmitting conductive film), and the electro-optical device 100 is formed as a transmission-type liquid crystal apparatus. In the electro-optical device 100, light emitted from a light source section is modulated for each pixel by the electro-optical layer 80 while the light is incident on one substrate side of the element substrate 10 and the counter substrate 20 and the light is emitted from another substrate side in an electronic apparatus, such as a projection-type display apparatus, which will be described later, thereby displaying an image. In the embodiment, as illustrated by an arrow L in FIG. 2, light emitted from the light source section is modulated for each pixel by the electro-optical layer 80 while the light is incident on the side of the element substrate 10 and is emitted from the side of the counter substrate 20, thereby displaying an image. In the electro-optical device 100 of the embodiment, a parting 7b, which includes a light-shield layer extending along the outer periphery of the display area 10a, is formed in the element substrate 10, which is located on the side on which light is incident, of the element substrate 10 and the counter substrate 20. In addition, dummy pixel electrodes 9b, which are simultaneously formed with the pixel electrodes 9a, are formed in a dummy pixel area 10c, which overlaps the parting 7b in plan view, in the peripheral area 10b of the element substrate 10. It is preferable to form the parting 7b on a side of the counter substrate 20 rather than lenses 14, which will be described later, and on a layer (incident side) which is close to the lenses 14 among the various wiring layers. For example, the parting 7b is formed between a layered structure 15 and an adhesive layer 17.

### Configuration of Plan Surface of Element Substrate 10

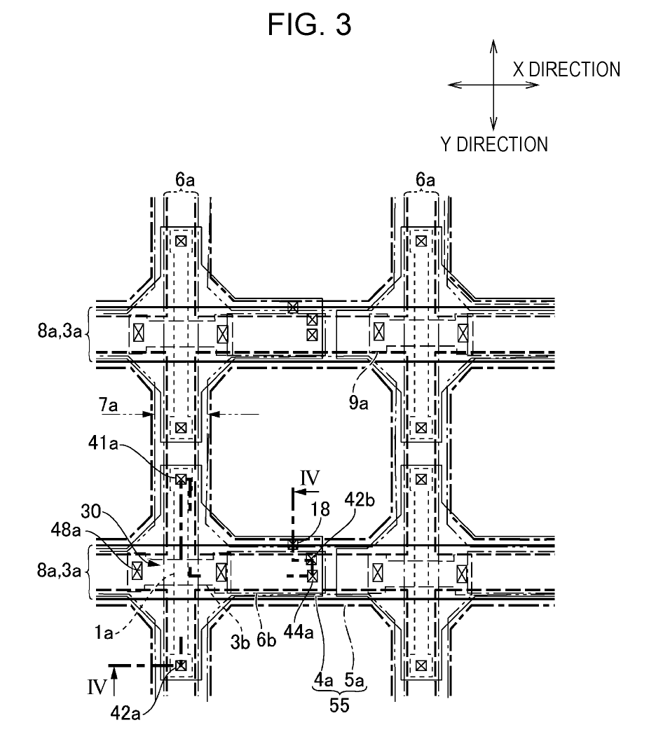

FIG. 3 is a plan view illustrating a plurality of pixels which are adjacent to each other in the electro-optical device 100 illustrated in FIG. 2. Meanwhile, in FIG. 3, respective layers are indicated by the lines described below. In addition, in FIG. 3, with regard to layers which have terminals overlapping each other in plan view, the positions of the terminals are shifted such that the shapes or the like of the layers are easily understood.

Thick solid line denotes a scan line 3a (first light-shield layer 8a)

Thin and short dotted line denotes a semiconductor layer 1a

Thin and long broken line denotes a gate electrode 3b

Thin solid line denotes a drain electrode 4a

Thin one-dot chain line denotes a data line 6a and a relay electrode 6b

Thick one-dot chain line denotes a capacitance electrode 5a

Thin two-dot chain line denotes a second light-shield layer 7a

Thick broken line denotes a pixel electrode 9a

As illustrated in FIG. 3, the pixel electrodes 9a are formed in the respective plurality of pixels on the surface of the element substrate 10, which faces the counter substrate 20, and the data lines 6a and the scan lines 3a are formed along inter pixel areas interposed by the adjacent pixel electrodes 9a. The inter-pixel areas extend horizontally and vertically, the scan lines 3a extend linearly along a first inter-pixel area of the inter-pixel areas, which extends in the X direction, and the data lines 6a extend linearly along a second inter-pixel area which extends in the Y direction. In addition, the pixel switching elements 30 are formed to correspond to the intersections of the data lines 6a and the scan lines 3a. In the embodiment, the pixel switching elements 30 are formed using intersection areas between the data lines 6a and the scan lines 3a and the vicinity thereof. A first light-shield layer 8a is formed on an upper layer side of the pixel switching elements 30, and the first light-shield layer 8a extends as scan lines 3a in the X direction. In the element substrate 10, a second light-shield layer 7a is formed as capacitance lines on the lower layer side of the pixel switching elements 30, and a common potential Vcom is applied to the second light-shield layer 7a. The second light-shield layer 7a extends to overlap the scan lines 3a and the data lines 6a and is formed in a lattice shape. Sectional configuration of element substrate 10

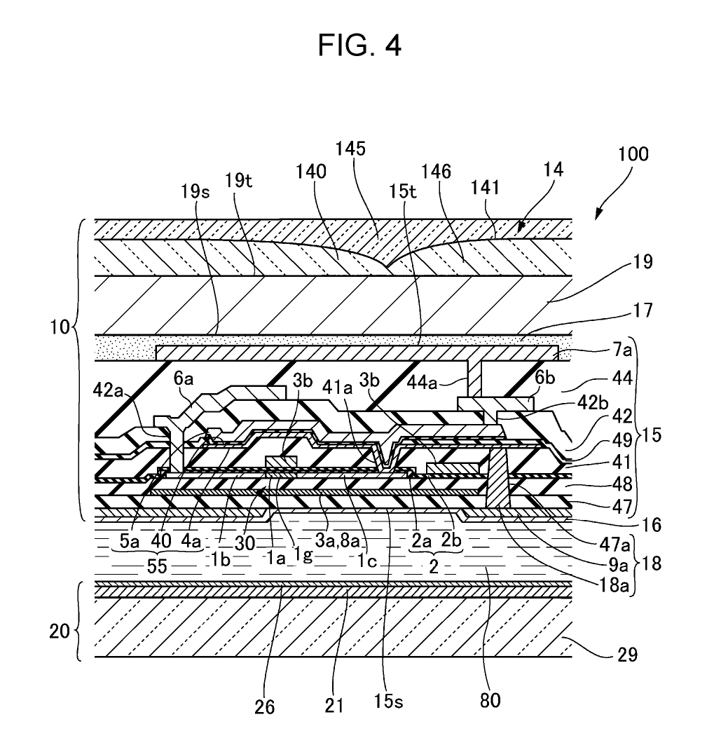

FIG. 4 is a sectional view illustrating a part of the electro-optical device 100 illustrated in FIG. 2, and is a sectional view taken along line IV-IV of FIG. 3. As illustrated in FIGS. 2 and 4, the element substrate 10 is provided with the pixel electrodes 9a, the pixel switching elements 30 electrically connected to the pixel electrodes 9a, and the holding capacitor 55 electrically connected to the pixel electrodes 9a. In the embodiment, the element substrate 10 includes the layered structure 15 having a plurality of films which include a film that forms the pixel switching elements 30 and a film that forms the holding capacitor 55, a lens surface 141 (first lens surface), which includes a concave surface or a convex surface that overlaps the pixel electrode 9a in plan view that is viewed from a direction perpendicular to the plane surface of the element substrate 10 on a side of the layered structure 15, which is opposite to the counter substrate 20, and a light-transmitting lens layer 145 (first lens layer) which covers the lens surface 141 from a side opposite to the layered structure 15.

Here, the holding capacitor 55 is provided on a side of the pixel switching element 30, which is opposite to the counter substrate 20. The pixel electrode 9a is provided on a side of the counter substrate 20 of the layered structure 15.

The layered structure 15 includes a protective film 47, which includes a silicon oxide film, on a first surface 15s which is a surface on the side of the counter substrate 20 (on a side, which is opposite to the holding capacitors 55, of the pixel switching elements 30). The first light-shield layer 8a, which includes a conductive film such as a conductive polysilicon film, a metal silicide film, a metal film or a metal compound film, is formed on the lower layer side of the protective film 47. In the embodiment, the first light-shield layer 8a is formed of a light-shield film, such as tungsten silicide (WSi), tungsten, or titanium nitride, and prevents light, which is emitted from the side of the element substrate 10, from being reflected in another member and being incident on the semiconductor layer 1a of the pixel switching elements 30. In the embodiment, the first light-shield layer 8a is formed as the scan line 3a. The scan line 3a is electrically connected to the gate electrode 3b, which will be described later, via the contact hole 48a. In addition, the scan line 3a is formed as a back gate of the pixel switching element 30.

A light-transmitting insulation film 48, which includes a silicon oxide film, is formed on the lower layer side of the first light-shield layer 8a, and the pixel switching element 30, which includes the semiconductor layer 1a, is formed on the lower layer side of the insulation film 48. The pixel switching element 30 includes the semiconductor layer 1a and the gate electrode 3b which extends in a direction orthogonal to the longitudinal direction of the semiconductor layer 1a and overlaps the central part of the longitudinal direction of the semiconductor layer 1a. The pixel switching element 30 includes a light-transmitting gate insulation layer 2 between the semiconductor layer 1a and the gate electrode 3b. The semiconductor layer 1a includes a channel area 1g, which faces the gate electrode 3b through the gate insulation layer 2, and includes a source area 1b and a drain area 1c on both sides of the channel area 1g. In the embodiment, the pixel switching element 30 has an LDD structure. Accordingly, the source area 1b and the drain area 1c respectively include low concentration areas on both sides of the channel area 1g and include high-concentration areas in areas which are adjacent to the channel area 1g on a side opposite to the low concentration areas.

The semiconductor layer 1a is formed of a polysilicon film (polycrystalline silicon film) or the like. The gate insulation layer 2 includes a two-layered structure which includes a first gate insulation layer 2a that is formed of a silicon oxide film acquired by performing thermal oxidation on the semiconductor layer 1a, and a second gate insulation layer 2b that is formed of a silicon oxide film formed by a decompression CVD method or the like. The gate electrode 3b and the scan line 3a include a conductive film such as a conductive polysilicon film, a metal silicide film, a metal film, or a metal compound film.

A light-transmitting inter-layer insulation film 41, which includes the silicon oxide film, is formed on the lower layer side of the gate electrode 3b, and the drain electrode 4a is formed on the lower layer side of the inter-layer insulation film 41. The drain electrode 4a includes the conductive film such as the conductive polysilicon film, the metal silicide film, the metal film, or the metal compound film. The drain electrode 4a is formed such that a part of the drain electrode 4a overlaps the drain area 1c of the semiconductor layer 1a and the drain electrode 4a is electrically connected to the drain area 1c through a contact hole 41a which passes through the inter-layer insulation film 41 and the gate insulation layer 2.

An insulation film 49 for a light-transmitting etching stopper and a light-transmitting dielectric layer 40, which include a silicon oxide film or the like, are formed on the lower layer side of the drain electrode 4a, and the capacitance electrode 5a is formed on the lower layer side of the dielectric layer 40. It is possible to use silicon compounds, such as a silicon oxide film and a silicon nitride film, as the dielectric layer 40. In addition, it is possible to use a dielectric layer, such as an aluminum oxide film, a titanium oxide film, a tantalium oxide film, a niobium oxide film, a hafnium oxide film, a lanthanum oxide film, or a zirconium oxide film, which has a high dielectric constant. The capacitance electrode 5a includes a conductive film, such as a conductive polysilicon film, a metal silicide film, a metal film, or a metal compound film. The capacitance electrode 5a overlaps the drain electrode 4a through the dielectric layer 40, and forms the holding capacitor 55 using the capacitance electrode 5a, the dielectric layer 40, and the drain electrode 4a.

A light-transmitting inter-layer insulation film 42, which includes a silicon oxide film or the like, is formed on the lower layer side of the capacitance electrode 5a, and the data line 6a and the relay electrode 6b are formed by the same conductive film on the lower layer side of the inter-layer insulation film 42. The data line 6a and the relay electrode 6b include the conductive film such as the conductive polysilicon film, the metal silicide film, the metal film or the metal compound film. The data line 6a is electrically connected to the source area 1b through the contact hole 42a which passes through the inter-layer insulation film 42, the insulation film 49, the inter-layer insulation film 41, and the gate insulation layer 2. The relay electrode 6b is electrically connected to the capacitance electrode 5a through the contact hole 42b which passes through the inter-layer insulation film 42.

A light-transmitting inter-layer insulation film 44, which includes the silicon oxide film, is formed on the lower layer side of the data line 6a and the relay electrode 6b, and the second light-shield layer 7a is formed by the conductive film on the lower layer side of the inter-layer insulation film 44. The surface of the inter-layer insulation film 44 is flattened. The second light-shield layer 7a includes the conductive film such as the conductive polysilicon film, the metal silicide film, the metal film, or the metal compound film. In the embodiment, the second light-shield layer 7a is formed as the capacitance line, and is electrically connected to the relay electrode 6b through the contact hole 44a. In the embodiment, the second light-shield layer 7a extends to overlap the data line 6a, the scan line 3a, and the pixel switching elements 30, and functions as a light-shield layer.

The pixel electrode 9a, which includes the ITO film, is formed on the upper layer side of the protective film 47 on a first surface 15s of the layered structure 15, and the first light-transmitting oriented film 16, which includes a polyimide or an inorganic oriented film, is formed on the upper layer side of the pixel electrode 9a. The pixel electrode 9a and the drain electrode 4a partially overlap with each other in plan view, and a connection section 18, which electrically connects the pixel electrode 9a and the drain electrode 4a, is formed between the pixel electrode 9a and the drain electrode 4a. In the embodiment, the connection section 18 includes a contact hole 47a which passes through the protective film 47, the insulation film 48, the gate insulation layer 2, and the inter-layer insulation film 41, and a plug 18a which includes a metal film filled in the contact hole 47a. The plug 18a is formed of tungsten or the like.

### Configuration of Lens Array Substrate 19

In the element substrate 10, which is described with reference to FIGS. 2, 3, and 4, the light-shield layer, which includes the data lines 6a and the like, and the pixel switching elements 30 are formed, and the light-shield layer and the pixel switching elements 30 do not transmit light. Therefore, in the element substrate 10, in the areas which overlap the pixel electrodes 9a in plan view, areas, which overlap the light-shield layers and the pixel switching elements 30 in plan view, and areas, which overlap areas interposed by adjacent pixel electrodes 9a, become light-shield areas which do not transmit light. In contrast, in the areas which overlap the pixel electrodes 9a in plan view, areas, which do not overlap the light-shield layers and the pixel switching elements 30 in plan view, become pixel opening areas (light-transmitting area) which transmit light. Accordingly, only light which passes through the opening areas contributes to display of an image, and light which faces the light-shield areas does not contribute to display of the image.

Here, in the element substrate 10, the plurality of lenses 14, which respectively overlap the plurality of pixel electrodes 9a in plan view with one-to-one relationship, are formed on a second surface 15t of the layered structure 15. The lenses 14 guide light to the pixel opening areas.

In a case where the lenses 14 are formed, the element substrate 10 includes a lens array substrate 19 which has one surface 19s pasted to the second surface 15t of the layered structure 15 by the adhesive layer 17. On another surface 19t of the lens array substrate 19, a plurality of lens surfaces 141, which include convex surfaces that respectively overlap the plurality of pixel electrodes 9a in plan view with one-to-one relationship, are formed. In addition, on another surface 19t of the lens array substrate 19, the lens layer 145 is formed to cover the lens surfaces 141. A hemispherical convex section 140, which forms the lens surface 141, has a different refractive index from the lens layer 145, and the lens surface 141 and the lens layer 145 form the lenses 14. In the embodiment, the refractive index of the convex section 140 is larger than the refractive index of the lens layer 145. For example, the lens layer 145 is formed of silicon oxide (SiO₂) and has a refractive index of 1.48. In contrast, the convex section 140 is formed of silicon oxynitride film (SiON) and has a refractive index of 1.58 to 1.68. Therefore, the lenses 14 have power to converge light from light sources.

In a case where the convex section 140 (lens surface 141) is formed, a silicon oxynitride film (light-transmitting film 146) is formed on another surface of the lens array substrate 19, a hemispherical resin convex section is formed on a surface of the silicon oxynitride film, thereafter, the convex section and the silicon oxynitride film are etched through dry etching using an Inductively Coupled Plasma (ICP) apparatus or the like. As a result, the convex section 140 (lens surface 141) is formed. Meanwhile, the resin convex section is developed in such a way that, for example, a positive type photosensitive resin is applied and the photosensitive resin is exposed using a gray scale mask or the like.

### Configuration of Counter Substrate 20

In the counter substrate 20, a light-shield layer 27, a protective layer 28, which includes a silicon oxide film or the like, and the common electrode 21, which includes the light-transmitting conductive film such as an ITO film, are formed on a surface (one surface 29s which faces the element substrate 10) on a side of the electro-optical layer 80 of a light-transmitting substrate 29 (light-transmitting substrate) such as a quartz substrate and a glass substrate, and a second light-transmitting oriented film 26, which includes a polyimide or an inorganic oriented film, is formed to cover the common electrode 21. In the embodiment, the common electrode 21 includes the ITO film.

Method of manufacturing electro-optical device 100

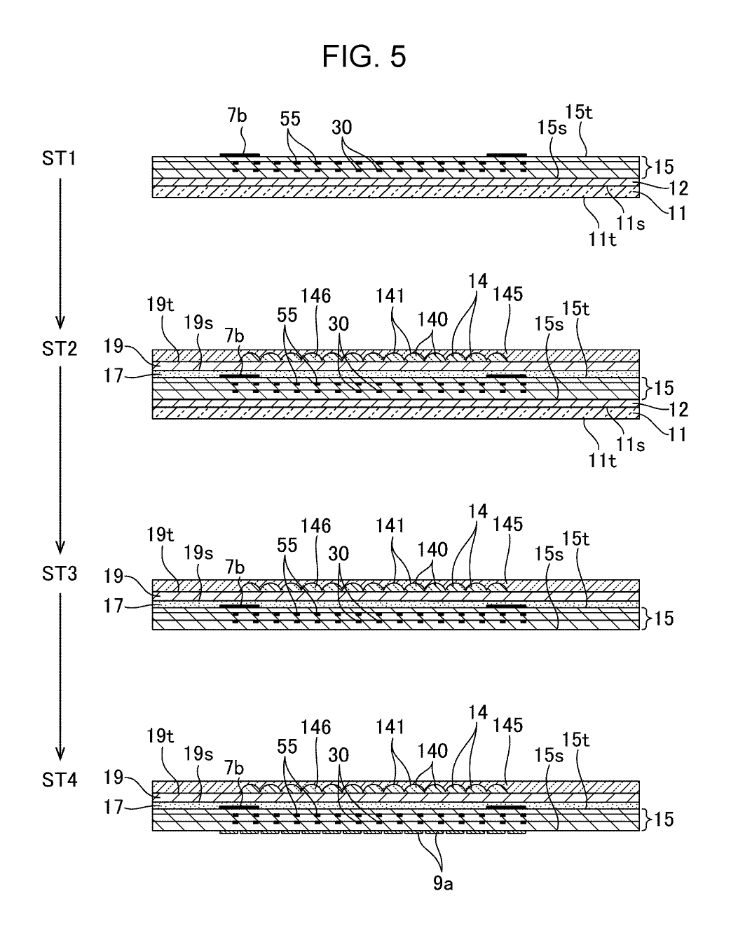

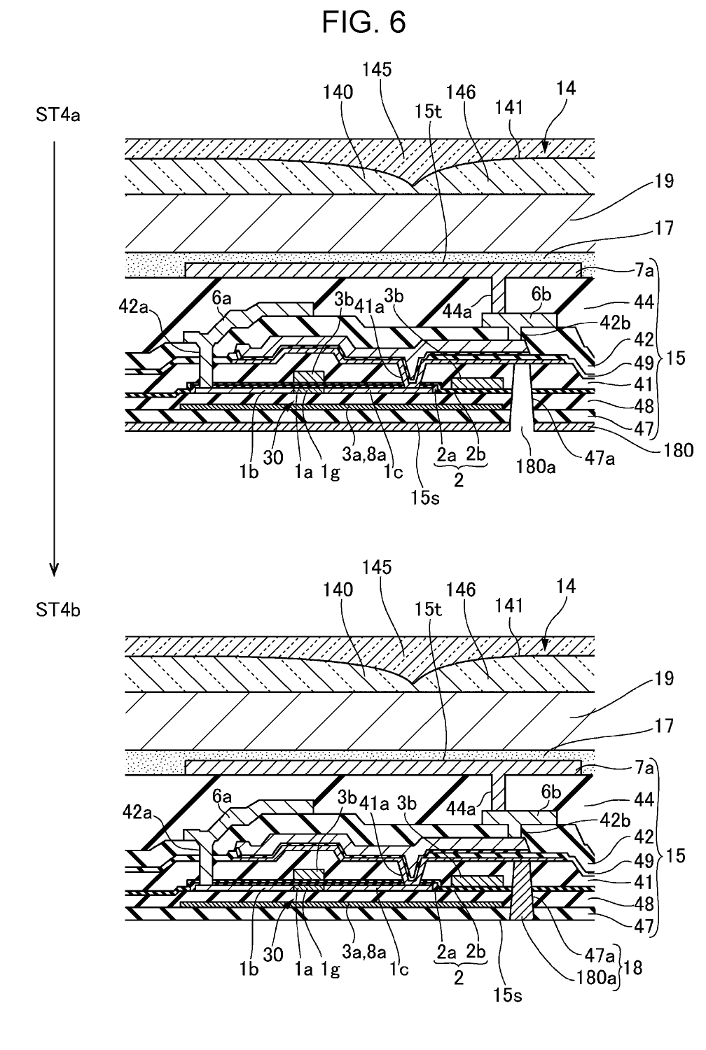

FIG. 5 is a sectional view illustrating steps of a method of manufacturing the electro-optical device 100 illustrated in FIG. 2. FIG. 6 is a sectional view illustrating steps of a method of forming the connection section 18 illustrated in FIG. 4. Meanwhile, in FIG. 5, up and down directions correspond to directions illustrated in FIG. 2, and, in each step, there is a case where the step is performed while the up and down directions are reversed. In the method of manufacturing the electro-optical device 100 according to the embodiment, a mother substrate, which is larger than the element substrate 10 and the lens array substrate 19 in a single size, is used in a step of manufacturing the element substrate 10. However, in the description below, the element substrate 10 and the lens array substrate 19 will be described regardless of the single size and the mother substrate.

In a case where the electro-optical device 100 according to the embodiment is manufactured, the following steps are performed in the steps of manufacturing the element substrate 10.

Element forming step ST1

Lens forming step ST2

Substrate removing step ST3

Pixel electrode forming step ST4

In an element forming step ST1, the pixel switching elements 30, the holding capacitors 55, and the like are sequentially formed on one surface 11s of the substrate 11, and the layered structure 15 is formed which includes a plurality of films having a film that forms the pixel switching elements 30 and a film that forms the holding capacitors 55. In the embodiment, in an etching stopper forming step, an etching stopper layer 12 is formed on the entire surface of the one surface 11s of the substrate 11, and then the protective film 47, the first light-shield layer 8a, the insulation film 48, the pixel switching elements 30, the holding capacitor 55, the data line 6a, and the like, which are described with reference to FIG. 4, are sequentially formed. The etching stopper layer 12 includes a polysilicon film and a tungsten silicide film.

Subsequently, in a lens forming step ST2, the lens surface 141 and the lens layer 145 are provided on the second surface 15t of the layered structure 15. In the embodiment, positions of the lens array substrate 19 and the layered structure 15 are aligned such that the pixel electrodes 9a and the lens surface 141 overlap the lens array substrate 19 and the layered structure 15 in plan view. Here, an adhesive is applied to at least one of the lens array substrate 19 and the layered structure 15, with the result that the lens array substrate 19 and the layered structure 15 are superimposed while the adhesive is interposed therebetween, thereafter, the adhesive is solidified, and thus the lens array substrate 19 and the layered structure 15 are pasted by the adhesive layer 17.

Subsequently, in a substrate removing step ST3, the substrate 11 is removed from another surface lit of the substrate 11. In the embodiment, both the substrate 11 and the etching stopper layer 12 are removed. More specifically, after polishing is performed on another surface lit of the substrate 11 through rough polishing and mechanical polishing, a flattening step, such as a Chemical Mechanical Polishing (CMP) process, is performed. Subsequently, an etching step of etching the substrate 11 until the etching stopper layer 12 is exposed due to a hydrofluoric acid-containing etching liquid is performed using a spin etcher or the like, and the substrate 11 is completely removed. Subsequently, the etching stopper layer 12 is removed through a dry etching process or a CMP process.

Subsequently, in a pixel electrode forming step ST4, the pixel electrodes 9a are formed on the first surface 15s of the layered structure 15. Here, after a step of forming the connection section 18 which is described with reference to FIG. 4 is performed, the pixel electrodes 9a are formed. More specifically, as illustrated in FIG. 6, after the substrate removing step ST3 is performed, an etching mask 180 is formed on the first surface 15s of the layered structure 15 in the contact hole forming step ST4a, etching is performed from an opening section 180a of the etching mask 180, and the contact hole 47a, which passes through the protective film 47, the insulation film 48, the gate insulation layer 2, and the inter-layer insulation film 41, is formed. An inner wall of the contact hole 47a has a tapered surface in which an inner diameter becomes narrower from the first surface 15s of the layered structure 15 toward the drain electrode 4a of the pixel switching elements 30. Subsequently, in a plug forming step ST4b, after a conductive film, such as tungsten, is formed on the first surface 15s of the layered structure 15 such that the contact hole 47a is filled, the CMP process is performed on the first surface 15s of the layered structure 15. As a result, a plug 18a remains on the inside of the contact hole 47a, and thus the connection section 18 is formed. Thereafter, as illustrated in FIGS. 2 and 4, the light-transmitting conductive film, such as the ITO film, is formed on the first surface 15s of the layered structure 15, the light-transmitting conductive film is etched, and the pixel electrodes 9a are formed.

Thereafter, after the first oriented film 16 is formed to cover the pixel electrodes 9a, as illustrated in FIGS. 1 and 2, the element substrate 10 and the counter substrate 20 are pasted by the seal material 107, and then the electro-optical layer 80 is injected between the element substrate 10 and the counter substrate 20.

### Main Advantage of Embodiment

As described above, in the element substrate 10 which is used in the electro-optical device 100 according to the embodiment, the pixel electrodes 9a are provided on the first surface 15s of the layered structure 15, which includes the plurality of films having the film that forms the pixel switching elements 30 and the film that forms the holding capacitors 55, and the lens surface 141 (first lens surface) and the lens layer 145 (first lens layer) are provided on the second surface 15t of the layered structure 15. Therefore, since the lens layer 145 is formed after the pixel switching elements 30 or the like are formed, heat generated when the semiconductor layer 1a of the pixel switching elements 30 is formed, and heat generated when the gate insulation layer 2 is formed are not added to the lens layer 145. Accordingly, even in a condition in which a difference in thickness of the lens layer 145 is large in an in-plane direction, it is possible to prevent a situation in which stress is concentrated on specific spots of the lens layer 145 due to the difference in thickness. Therefore, it is possible to prevent a problem, in which cracks are generated in the lens layer 145, and a problem, in which the lens layer 145 is peeled of due to the cracks, from being generated.

In addition, after the pixel switching elements 30 and the holding capacitors 55 are formed on one surface of the substrate 11, the whole substrate 11 is removed. Therefore, even in a case where the lenses 14 are provided in the element substrate 10, it is possible to prevent the element substrate 10 from being thick. In addition, since it is possible to make the element substrate 10 thin, it is possible to effectively dissipate heat, generated when wiring or the like absorbs light, in the element substrate 10. In addition, in the embodiment, in a case where the lenses 14 are provided, the lens array substrate 19 is pasted to the layered structure 15, and thus it is possible to design lenses having a high degree of freedom. Therefore, it is possible to increase light use efficiency. In addition, a configuration in which the layered structure 15 and the lens array substrate 19 are pasted has sufficient rigidity, and thus it is possible to smoothly perform each of the steps.

In addition, in the electro-optical device 100, through which light that is emitted from the light source section is incident on the side of the element substrate 10 and is emitted from the side of the counter substrate 20, the lens surface 141 is formed on the side of the element substrate 10. Therefore, in a state in which an optical compensation element, such as an O plate or a C plate, is provided in the counter substrate 20 on a side opposite to the element substrate 10 and the electro-optical layer 80, a structure, such as the wirings which surround the lenses 14 and the pixel opening sections, does not exist between the electro-optical layer 80 and the optical compensation element. Accordingly, a situation, in which advantage attributable to the optical compensation element is obstructed by the structure such as the wirings which surround the lenses 14 and the pixel opening sections, is hardly generated. Therefore, deterioration in image contrast is hardly generated. In addition, in the electro-optical device 100 through which light that is emitted from the light source section is incident on the side of the element substrate 10 and is emitted from the side of the counter substrate 20, the second light-shield layer 7a (capacitance line) and the data line 6a are provided on the pixel switching elements 30 on a side on which light from the light source is incident. Therefore, since it is possible to prevent light from being incident on the pixel switching elements 30 using the second light-shield layer 7a (capacitance line) and the data line 6a, it is possible to prevent image qualities from being deteriorated due to optical leak current of the pixel switching elements 30. Therefore, it is preferable that the second light-shield layer 7a (capacitance line) and the data line 6a have a multi-layer structure which functions as a light reflection layer, such as an aluminum layer, for a side on which light from the light source is incident, and functions as an optical absorption layer, such as a titanium layer, a titanium nitride layer, a tungsten layer, a tungsten silicide layer, a chrome layer, and a molybdenum layer, for an opposite side thereof. According to the configuration, it is possible to reflect light from the light source by the light reflection layer, and it is possible to absorb light, which returns from the opposite side, by the optical absorption layer, thereby being effective to prevent generation of stray light.

In addition, in the embodiment, in a case where the element substrate 10 is manufactured, the etching stopper layer 12 is formed on one surface 11s of the substrate 11, and the substrate 11 is removed through etching until reaching the etching stopper layer 12. Accordingly, it is easy to control end point of the etching, and thus it is possible to prevent excessive etching.

### Second Embodiment

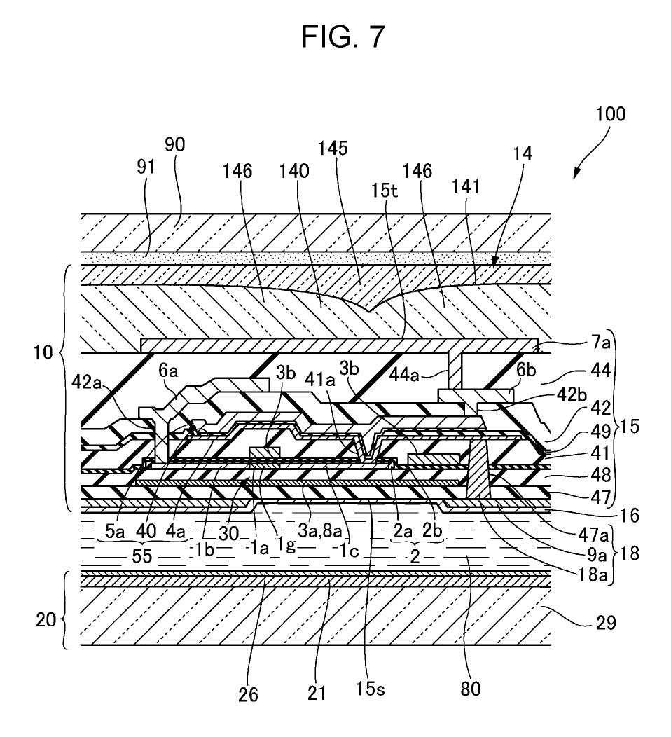

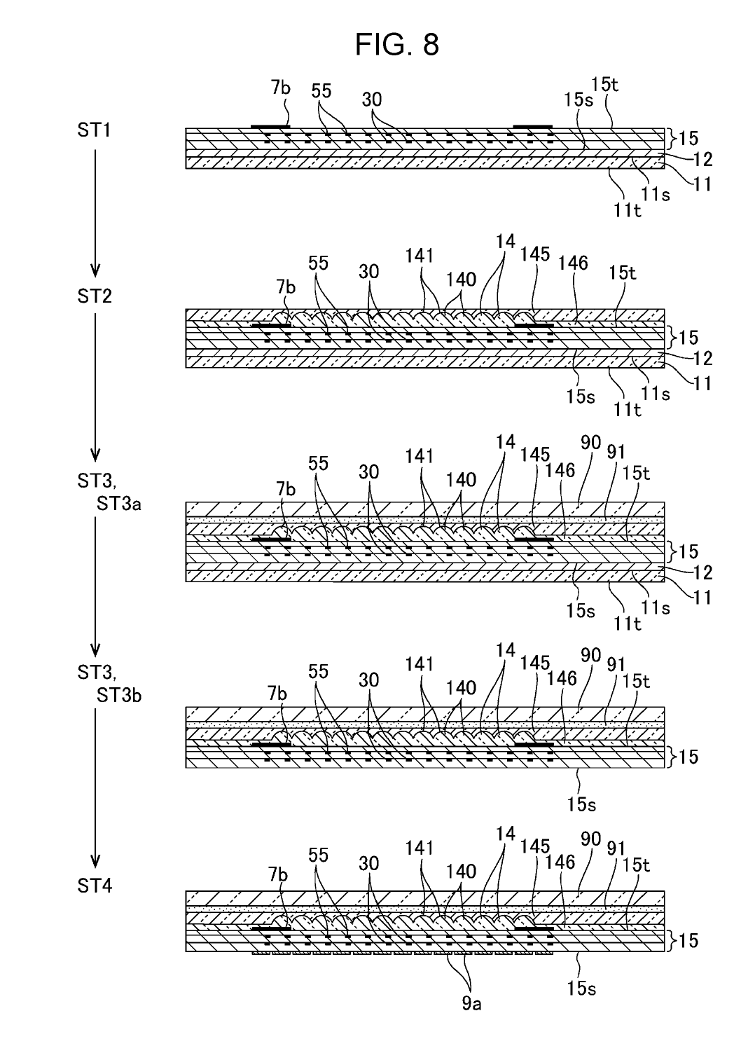

FIG. 7 is a sectional view illustrating an electro-optical device 100 according to a second embodiment of the invention. FIG. 8 is a sectional view illustrating steps of a method of manufacturing the electro-optical device 100 illustrated in FIG. 7. Meanwhile, since basic configurations of the second embodiment and third, fourth, and fifth embodiments, which will be described later, are the same as in the first embodiment, common parts are illustrated using the same numerical symbols and the description thereof will not be repeated.

In the first embodiment, the lens array substrate 19 is pasted to the second surface 15t of the layered structure 15. However, in the embodiment, the convex section 140 (lens surface 141) is formed on the light-transmitting film 146, which includes a silicon oxynitride film laminated on the second surface 15t of the layered structure 15, as illustrated in FIG. 7. Therefore, in the element substrate 10, the lens array substrate is not used. In addition, a support substrate 90 is pasted to the light-transmitting film 146 on a side opposite to the layered structure 15 through an adhesive layer 91.

In a case where the electro-optical device 100 according to the embodiment is manufactured, the following steps are performed in steps of manufacturing the element substrate 10, as illustrated in FIG. 8.

Element forming step ST1

Lens forming step ST2

Substrate removing step ST3

Pixel electrode forming step ST4

In an element forming step ST1, the pixel switching elements 30, the holding capacitors 55, and the like are sequentially formed on one surface 11s of the substrate 11, and the layered structure 15, which includes the plurality of films having the film that forms the pixel switching elements 30 and the film that forms the holding capacitors 55, is formed. In the embodiment, in the etching stopper forming step, after the etching stopper layer 12 is formed on the entire surface of the one surface 11s of the substrate 11, the protective film 47, the first light-shield layer 8a, the insulation film 48, the pixel switching elements 30, the holding capacitors 55, the data line 6a, and the like, which are described with reference to FIG. 7, are sequentially formed. The etching stopper layer 12 includes a poly silicon film and a tungsten silicide film.

Subsequently, in a lens forming step ST2, after the light-transmitting film 146 which includes a silicon oxynitride film is formed on the second surface 15t of the layered structure 15, the convex section 140 (lens surface 141) is formed, and, thereafter, the lens layer 145 is formed to cover the lens surface 141.

Subsequently, in a substrate removing step ST3, the substrate 11 is removed from another surface lit of the substrate 11. In the embodiment, in a support substrate pasting step ST3a, the support substrate 90 is pasted to the lens layer 145 on a surface opposite to the layered structure 15 through the adhesive layer 91. In the state, in a removing step ST3b, both the substrate 11 and etching stopper layer 12 are removed through the CMP process and etching step.

Subsequently, in a pixel electrode forming step ST4, the pixel electrodes 9a are formed on the first surface 15s of the layered structure 15. Here, after the connection section 18 (the contact hole 47a and the plug 15s) illustrated in FIG. 7 is formed, the pixel electrodes 9a are formed. Subsequently, the electro-optical device 100 is manufactured in such a way that the element substrate 10 in a state in which the support substrate 90 is provided to the layered structure 15 is pasted to the counter substrate 20. Accordingly, the support substrate 90 remains in the electro-optical device 100.

According to the embodiment, it is possible to prevent the problem in that cracks are generated in the lens layer 145 and the problem in that the lens layer 145 is peeled off due to the cracks from being generated, and thus the same advantage as in the first embodiment is acquired. In addition, in the embodiment, the lens array substrate 19 is not used. However, since the support substrate 90 is pasted to the layered structure 15, sufficient rigidity is acquired. Accordingly, it is possible to stably perform the substrate removing step ST3 and the pixel electrode forming step ST4. In addition, in a case where the lenses 14 are provided, the lenses 14 are formed using a semiconductor process, such as film formation, exposure, and the like performed on the layered structure 15 without pasting the lens array substrate 19. Therefore, it is possible to perform positioning of the substrate in the in-plane direction with alignment accuracy of the exposure machine. Accordingly, the positioning accuracy between the lenses 14 and the pixel opening sections is high. In addition, as in the embodiment, in a case where the support substrate 90 remains in the electro-optical device 100, it is preferable to use a quartz substrate or a sapphire substrate as the support substrate 90. In a case where the support substrate 90 is a crystal substrate or the sapphire substrate, thermal conductivity of the support substrate 90 is high, and thus it is possible to effectively release heat generated in the element substrate 10 through the support substrate 90.

### Third Embodiment

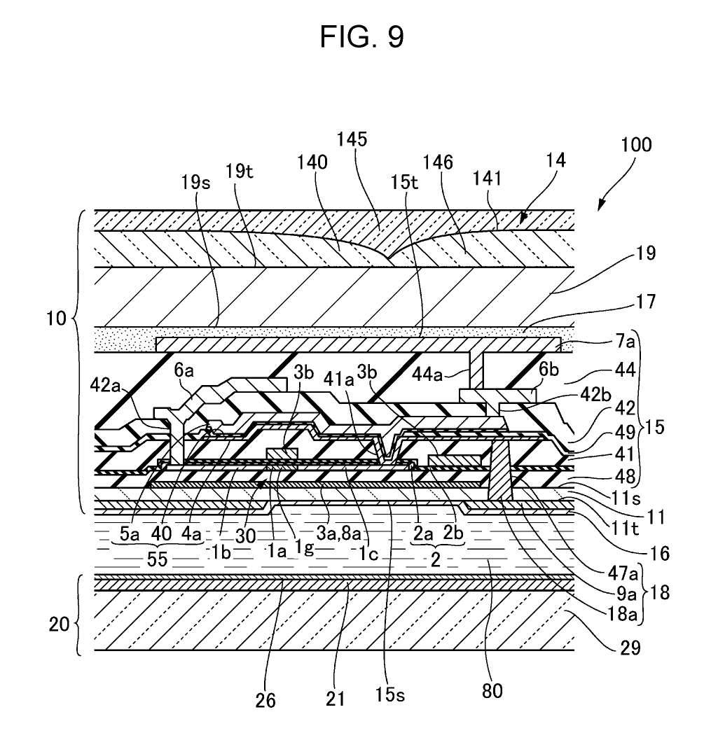

FIG. 9 is a sectional view illustrating an electro-optical device 100 according to a third embodiment of the invention. In the first and second embodiments, the substrate 11 is completely removed in the substrate removing step ST3. However, the light-transmitting substrate may be used as the substrate 11, and the substrate 11 may be thinned such that a part in a thickness direction remains in the substrate removing step ST3. In this case, the etching stopper layer 12 is not formed. In addition, it is not necessary to form the protective film 47.

In a case of the configuration, as illustrated in FIG. 9, the layered structure 15 is laminated on one surface 11s of the substrate 11, and the pixel electrode 9a is formed on another surface 11t of the substrate 11. Accordingly, in the connection section 18 which connects the pixel electrode 9a to the drain electrode 4a of the pixel switching elements 30, the contact hole 47a is formed to pass through the substrate 11, the insulation film 48, the gate insulation layer 2, and the inter-layer insulation film 41. Meanwhile, although the embodiment illustrated in FIG. 9 is acquired by applying the configuration of the third embodiment based on the first embodiment, the configuration of the third embodiment may be applied based on the second embodiment.

### Fourth Embodiment

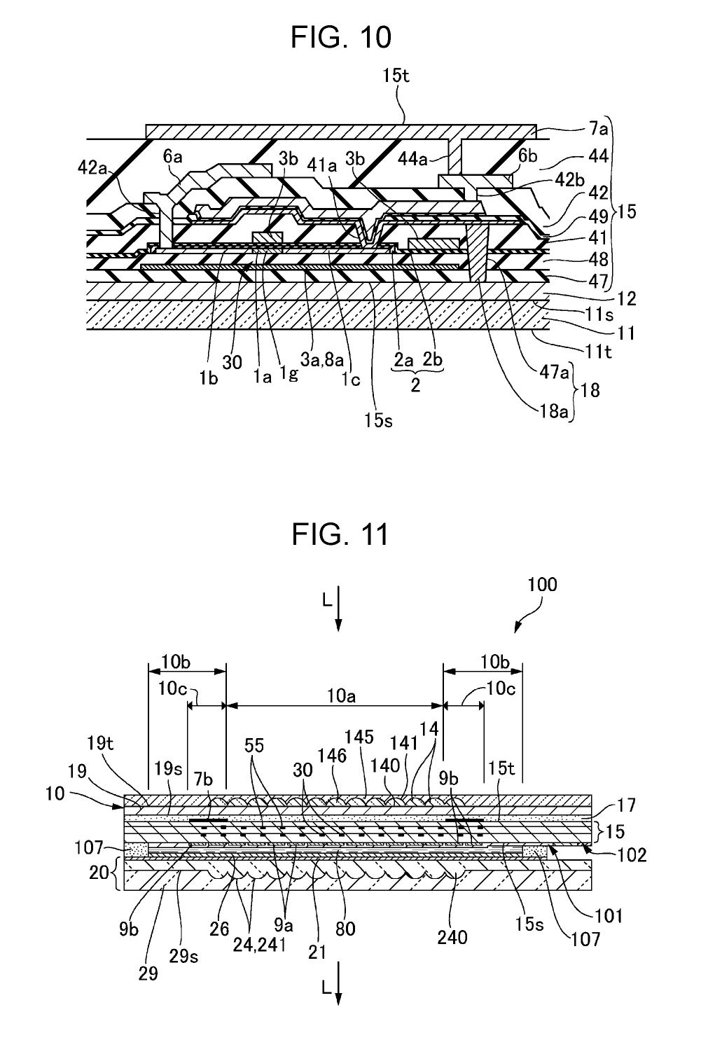

FIG. 10 is a sectional view illustrating an electro-optical device 100 according to a fourth embodiment of the invention. In the first embodiment or the like, the connection section 18 is formed to electrically connect the pixel switching elements 30 to the pixel electrode 9a after the substrate removing step ST3 and before the pixel electrode forming step ST4. However, in the embodiment, the connection section 18 is formed to electrically connect the pixel switching elements 30 to the pixel electrode 9a on one surface 11s of the substrate 11 in the element forming step ST1.

More specifically, as illustrated in FIG. 10, the plug 18a is formed after the inter-layer insulation film 41 is formed and after the contact hole 47a is formed toward the etching stopper layer 12 from the inter-layer insulation film 41. In the configuration, the inner wall of the contact hole 47a has a tapered surface in which an inner diameter becomes narrower from the drain electrode 4a of the pixel switching elements 30 toward the first surface 15s of the layered structure 15.

### Fifth Embodiment

FIG. 11 is a sectional view illustrating an electro-optical device 100 according to a fifth embodiment of the invention. In the first embodiment or the like, the lenses 14 are formed only on the side of the element substrate 10. However, as illustrated in FIG. 11, lenses 24 may be formed on the side of the counter substrate 20. That is, the counter substrate 20 includes the substrate 29, on which a lens surface 241 (second lens surface) that includes a concave surface or a convex surface that overlaps the pixel electrodes 9a in plan view, and a light-transmitting lens layer 240 (second lens layer) which covers the lens surface 241 is formed in the substrate 29. In the embodiment, the lens surface 241, which includes the concave surface, is formed on one surface 29s of the substrate 29, and the lens layer 240 includes a silicon oxynitride film which has a larger refractive index than the substrate 29. According to the configuration, it is possible to cause a part of light emitted from the counter substrate 20 to be parallel light by the lenses 24, with the result that it is possible to increase transmission efficiency for an element, such as a projection lens, which has a fixed uptake angle, and thus it is possible to improve image qualities.

### Another Embodiment

In the embodiment, the lens surface 141, which includes the convex surface, is formed. However, for example, the lens surface 141, which includes the concave surface, may be formed on one surface 19s of the lens array substrate 19, and the lens layer 145 (first lens layer), which includes the silicon oxynitride film, may be formed to cover the lens surface 141. In this case, with regard to the lens surface 141, for example, after the etching mask is formed on one surface 19s of the lens array substrate 19, isotropic etching is performed from opening sections of the etching mask, thereby forming the lens surface 141 which includes the concave surface.

In the embodiment, the pixel electrodes 9a are electrically connected to the drain electrodes 4a of the pixel switching elements 30 directly by the connection section 18. However, the pixel electrodes 9a may be electrically connected to the drain electrodes 4a of the pixel switching elements 30 by relaying the first light-shield layer 8a and an electrically-conductive layer on the same layer.

In the embodiment, the invention is applied to the electro-optical device 100 in a type in which light is incident on the side of the element substrate 10. However, the invention may be applied to an electro-optical device 100 in a type in which light is incident on the side of the counter substrate 20.

### Mounting Example on Electronic Apparatus

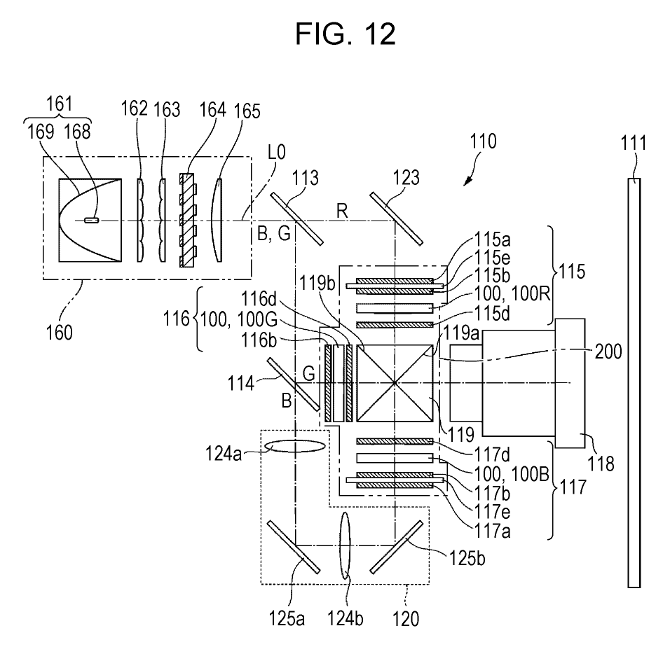

FIG. 12 is a schematic configuration view illustrating a projection-type display apparatus (electronic apparatus) using the electro-optical device 100 to which the invention is applied. Meanwhile, in the description below, a plurality of electro-optical devices 100, to which light having different wavelength areas is supplied, are used. However, the electro-optical device 100 to which the invention is applied is used for all the electro-optical devices 100.

The projection-type display apparatus 110 illustrated in FIG. 12 is a liquid crystal projector using the transmission-type electro-optical device 100, and displays an image by irradiating light to a projection member 111 which includes a screen or the like. The projection-type display apparatus 110 includes, along an optical axis L0 of the apparatus, a lighting device 160, a plurality of electro-optical devices 100 (liquid crystal light valves 115 to 117) to which light emitted from the lighting device 160 is supplied, a cross dichroic prism 119 (photosynthetic optical system) which synthesizes and emits light that is emitted from the plurality of electro-optical devices 100, and a projection optical system 118 which projects light synthesized by the cross dichroic prism 119. In addition, the projection-type display apparatus 110 includes dichroic mirrors 113 and 114, and a relay system 120, In the projection-type display apparatus 110, the electro-optical device 100 and the cross dichroic prism 119 form an optical unit 200.

In the lighting device 160, along the optical axis L0 of the apparatus, a light source section 161, a first integrator lens 162, which includes a lens array such as a fly-eye lens, a second integrator lens 163, which includes a lens array such as a fly-eye lens, a polarized light conversion element 164, and a condenser lens 165 are sequentially disposed. The light source section 161 includes a light source 168 which emits white light including red light R, green light G and blue light B, and a reflector 169. The light source 168 is formed of an extra-high pressure mercury lamp or the like, and the reflector 169 includes a parabolic cross section. The first integrator lens 162 and the second integrator lens 163 equalize the luminance distribution of light emitted from the light source section 161. The polarized light conversion element 164 causes light emitted from the light source section 161 to be polarized light which has a specific vibration direction similar to, for example, s-polarized light.

A dichroic mirror 113 causes red light R, which is included in light emitted from the lighting device 160, to pass therethrough, and reflects green light G and blue light B. A dichroic mirror 114 causes blue light B of green light G and blue light B, which are reflected in the dichroic mirror 113, to pass therethrough, and reflects green light G. As above, the dichroic mirrors 113 and 114 form a color separation optical system which separates light emitted from the lighting device 160 into red light R, green light G, and blue light B.

A liquid crystal light valve 115 is a transmission-type display apparatus that modulates red light R, which passes through the dichroic mirror 113 and is reflected in a reflection mirror 123, according to an image signal. The liquid crystal light valve 115 includes λ/2 phase difference plate 115a, a first polarizing plate 115b, an electro-optical device 100 (red electro-optical device 100R), and a second polarizing plate 115d. Here, even in a case where red light R, which is incident on the liquid crystal light valve 115, passes through the dichroic mirror 113, polarized light is not changed, and thus s-polarized light is not changed.

The λ/2 phase difference plate 115a is an optical element that converts s-polarized light which is incident on the liquid crystal light valve 115 into p-polarized light. The first polarizing plate 115b is a polarizing plate that cuts off s-polarized light and causes p-polarized light to pass therethrough. The electro-optical device 100 (red electro-optical device 100R) is formed to convert p-polarized light into s-polarized light (in a case of halftone, circularly polarized light or elliptically polarized light) through modulation according to the image signal. The second polarizing plate 115d is a polarizing plate that cuts off p-polarized light and causes s-polarized light to pass therethrough. Accordingly, the liquid crystal light valve 115 modulates red light R according to the image signal, and emits modulated red light R toward the cross dichroic prism 119. The λ/2 phase difference plate 115a and the first polarizing plate 115b are disposed in a state in which the λ/2 phase difference plate 115a and the first polarizing plate 115b come into contact with a light-transmitting glass plate 115e which does not convert polarized light, and it is possible to prevent distortion of the λ/2 phase difference plate 115a and the first polarizing plate 115b due to the generation of heat.

A liquid crystal light valve 116 is a transmission-type display apparatus that modulates green light G, which is reflected in the dichroic mirror 114 after being reflected in the dichroic mirror 113, according to the image signal. The liquid crystal light valve 116 includes a first polarizing plate 116b, an electro-optical device 100 (green electro-optical device 100G), and a second polarizing plate 116d, similar to the liquid crystal light valve 115. Green light G, which is incident on the liquid crystal light valve 116, is s-polarized light which is reflected in and incident into the dichroic mirrors 113 and 114. The first polarizing plate 116b is a polarizing plate that cuts off p-polarized light and causes s-polarized light to pass therethrough. The electro-optical device 100 (green electro-optical device 100G) is formed to convert s-polarized light into p-polarized light (in a case of halftone, circularly polarized light or elliptically polarized light) through modulation according to the image signal. The second polarizing plate 116d is a polarizing plate that cuts off s-polarized light and causes p-polarized light to pass therethrough. Accordingly, the liquid crystal light valve 116 modulates green light G according to the image signal, and emits modulated green light G toward the cross dichroic prism 119.

The liquid crystal light valve 117 is a transmission-type liquid crystal apparatus that modulates blue light B, which is reflected in the dichroic mirror 113 and passes through the relay system 120 after passing through the dichroic mirror 114, according to the image signal. The liquid crystal light valve 117 includes a λ/2 phase difference plate 117a, a first polarizing plate 117b, an electro-optical device 100 (blue electro-optical device 100B), and a second polarizing plate 117d, similar to the liquid crystal light valves 115 and 116. Blue light B, which is incident on the liquid crystal light valve 117, is reflected in the two reflection mirrors 125a and 125b of the relay system 120 after being reflected in the dichroic mirror 113 and passing through the dichroic mirror 114, and thus blue light B becomes s-polarized light.

The λ/2 phase difference plate 117a is an optical element that converts s-polarized light, which is incident on the liquid crystal light valve 117, into p-polarized light. The first polarizing plate 117b is a polarizing plate that cuts off s-polarized light and causes p-polarized light to pass therethrough. The electro-optical device 100 (blue electro-optical device 100B) is formed to convert p-polarized light into s-polarized light (in a case of halftone, circularly polarized light or elliptically polarized light) through modulation according to the image signal. The second polarizing plate 117d is a polarizing plate that cuts off p-polarized light and causes s-polarized light to pass therethrough. Accordingly, the liquid crystal light valve 117 modulates blue light B according to the image signal, and emits modulated blue light B toward the cross dichroic prism 119. Meanwhile, the λ/2 phase difference plate 117a and the first polarizing plate 117b are disposed in a state in which the λ/2 phase difference plate 117a and the first polarizing plate 117b come into contact with a glass plate 117e.

The relay system 120 includes relay lenses 124a and 124b and reflection mirrors 125a and 125b. The relay lenses 124a and 124b are provided to prevent optical loss due to long optical path of blue light B. The relay lens 124a is disposed between the dichroic mirror 114 and the reflection mirror 125a. The relay lens 124b is disposed between the reflection mirrors 125a and 125b. The reflection mirror 125a reflects blue light B, which passes through the dichroic mirror 114 and is emitted from the relay lens 124a, toward the relay lens 124b. The reflection mirror 125b reflects blue light B, which is emitted from the relay lens 124b, toward the liquid crystal light valve 117.

The cross dichroic prism 119 is a color synthesis optical system in which two dichroic films 119a and 119b are perpendicularly disposed in an X-shape. The dichroic film 119a is a film which reflects blue light B and causes green light G to pass therethrough, and the dichroic film 119b is a film which reflects red light R and causes green light G to pass therethrough. Accordingly, the cross dichroic prism 119 synthesizes red light R, green light G, and blue light B which are modulated in respective liquid crystal light valves 115 to 117, and emits synthesized light toward the projection optical system 118.

Meanwhile, light which is incident on the cross dichroic prism 119 from the liquid crystal light valves 115 and 117 is s-polarized light, and light which is incident on the cross dichroic prism 119 from the liquid crystal light valve 116 is p-polarized light. As above, in a case where light which is incident on the cross dichroic prism 119 is converted into different types of polarized light, it is possible to synthesize light which is incident on each of the liquid crystal light valves 115 to 117 in the cross dichroic prism 119. Here, generally, the dichroic films 119a and 119b are excellent in reflectance properties of s-polarized light. Therefore, it is assumed that red light R and blue light B which are reflected in the dichroic films 119a and 119b are s-polarized light and green light G which passes through the dichroic films 119a and 119b is p-polarized light. The projection optical system 118 includes projection lenses (not shown in the drawing), and projects light which is synthesized in the cross dichroic prism 119 on to a projection member 111 such as the screen.

### Other Projection-Type Display Apparatuses

In the embodiment, although the λ/2 phase difference plates 115a, 116a, and 117a are disposed as the optical compensation elements, optical compensation elements, such as a C plate and an O plate, may be disposed. In this case, it is preferable that the optical compensation elements be provided between the electro-optical device 100 and the light source section 161. In the projection-type display apparatus, an LED light source, which emits light of the respective colors, or the like may be used as the light source section, and respective pieces of color light which are emitted from the LED light sources may be supplied to separate liquid crystal apparatuses.

The electro-optical device 100 to which the invention is applied may be used for a projection-type Head-Up Display (HUD) or a direct viewing type Head Mounted Display (HMD), a mobile phone, a Personal Digital Assistants (PDA), a digital camera, a liquid crystal television, a car navigation apparatus, a video phone and the like, in addition to the electronic apparatus.

The entire disclosure of Japanese Application No. 2016-074974, field Apr. 4, 2016 is expressly incorporated by reference herein.

What is claimed is:

1. A method of manufacturing an electro-optical device including an element substrate, on which pixel electrodes, pixel switching elements electrically connected to the pixel electrodes, and holding capacitors electrically connected to the pixel electrode are provided, a counter substrate on which common electrodes that face the pixel electrodes are provided, and an electro-optical layer which is provided between the element substrate and the counter substrate, the method comprising:
forming the element substrate including
forming a layered structure, which includes a plurality of films having a film that forms the pixel switching elements and a film that forms the holding capacitors, on one surface of the substrate;
removing the substrate from another surface of the substrate after the forming of the layered structure;
forming the pixel electrodes on a first surface of the layered structure which is a surface on a side, which is opposite to the holding capacitors, of the pixel switching elements, after the removing of the substrate; and
providing a first lens surface, which includes a concave surface or a convex surface, and a first light-transmitting lens layer, which covers the first lens surface, on a second surface, on which the holding capacitors are located for the pixel switching elements, of the layered structure after the forming of the layered structure is performed.

2. The method of manufacturing an electro-optical device according to claim 1,
wherein the removing of the substrate includes completely removing the substrate.

3. The method of manufacturing an electro-optical device according to claim 2,
wherein the forming of the element substrate includes forming the layered structure after forming an etching stopper layer on the one surface of the substrate, and
wherein the removing of the substrate includes etching the substrate to remove the substrate until reaching at least the etching stopper layer, and removing the etching stopper layer after the etching of the substrate.

4. The method of manufacturing an electro-optical device according to claim 1,
wherein the substrate is a light-transmitting substrate, and
wherein the removing of the substrate includes thinning the substrate and remaining a part of the substrate in a thickness direction.

5. The method of manufacturing an electro-optical device according to claim 1, further comprising:
pasting a lens array substrate, which includes the first lens surface and the first lens layer, to the second surface of the layered structure by an adhesive layer in the providing of the first lens surface and the first lens layer after the forming of the layered structure and before the removing of the substrate; and
performing the removing of the substrate and the forming of the pixel electrodes in a state in which the lens array substrate is pasted to the second surface of the layered structure.

6. The method of manufacturing an electro-optical device according to claim 1, further comprising:
forming a light-transmitting film on the second surface of the layered structure, and, thereafter, forming the first lens surface on the light-transmitting film in the providing of the first lens surface and the first lens layer after the forming of the layered structure and before the removing of the substrate; and
performing the removing of the substrate and the forming of the pixel electrodes in a state in which the support substrate is pasted to the second surface of the layered structure by an adhesive layer.

7. The method of manufacturing an electro-optical device according to claim 6,
wherein the support substrate is a light-transmitting substrate, and
wherein the support substrate remains in the electro-optical device.

8. The method of manufacturing an electro-optical device according to claim 7,
wherein the support substrate is a crystal substrate or a sapphire substrate.

9. The method of manufacturing an electro-optical device according to claim 1, further comprising:
forming a connection section, which electrically connects the pixel switching elements to the pixel electrodes, on the first surface of the layered structure after the removing of the substrate and before the forming of the pixel electrodes.

10. The method of manufacturing an electro-optical device according to claim 1, further comprising:
forming a connection section, which electrically connects the pixel switching elements to the pixel electrodes, on one surface of the substrate in the forming of the layered structure.

11. An electro-optical device comprising:
an element substrate, on which pixel electrodes, pixel switching elements electrically connected to the pixel electrodes, and holding capacitors electrically connected to the pixel electrode are provided;
a counter substrate on which common electrodes that face the pixel electrodes are provided; and
an electro-optical layer which is provided between the element substrate and the counter substrate,
wherein the element substrate includes a layered structure, which includes a plurality of films having a film that forms the pixel switching elements and a film that forms the holding capacitors, a first lens surface, which includes a concave surface or a convex surface that overlaps the pixel electrodes, on a side, which is opposite to the counter substrate, of the layered structure, and a first light-transmitting lens layer which covers the first lens surface from a side opposite to the layered structure,
wherein the holding capacitors are provided on a side opposite to the counter substrate for the pixel switching elements, and
wherein the pixel electrodes are provided on the counter substrate side of the layered structure.

12. The electro-optical device according to claim 11,
wherein the pixel electrodes are laminated on a surface of the layered structure on the counter substrate side, and
wherein a substrate is not provided between the pixel electrodes and the layered structure.

13. The electro-optical device according to claim 11,
wherein the element substrate includes a light-transmitting substrate between the pixel electrodes and the layered structure,
wherein the layered structure is laminated on a surface of the substrate on a side opposite to the counter substrate, and
wherein the pixel electrodes are laminated on a surface of the substrate on the counter substrate side.

14. The electro-optical device according to claim 11,
wherein the element substrate includes a lens array substrate which has the first lens surface and the first lens layer, and
wherein the lens array substrate is pasted to a surface of the layered structure on a side opposite to the counter substrate by an adhesive layer.

15. The electro-optical device according to claim 11,
wherein the element substrate includes a light-transmitting film, in which the first lens surface is formed, on a side, which is opposite to the counter substrate, of the layered structure.

16. The electro-optical device according to claim 15,
wherein the element substrate includes a light-transmitting support substrate on a side, which is opposite to the layered structure, of the light-transmitting film.

17. The electro-optical device according to claim 16,
wherein the support substrate is a crystal substrate or a sapphire substrate.

18. The electro-optical device according to claim 11,
wherein the counter substrate is provided with a second lens surface, which includes a concave surface or a convex surface that overlaps the pixel electrodes, and a second light-transmitting lens layer which covers the second lens surface.

19. An electronic apparatus comprising the electro-optical device according to claim 11.

20. The electronic apparatus according to claim 19, further comprising:
a light source section that causes light to be incident to the element substrate side for the electro-optical device.
